(19) United States
(12) Patent Application Publication
(10) Pub. No.: US 2018/0249130 A1
(43) Pub. Date: Aug. 30, 2018

(54) CENTRAL MONITORING SYSTEM AND METHOD FOR EFFICIENTLY MANAGING AND ASSURING THE SAFETY, QUALITY AND SECURITY OF GOODS STORED WITHIN A TRUCK, TRACTOR OR TRAILER

(71) Applicant: DAVID ARENA, HAMMONTON, NJ (US)

(72) Inventor: DAVID ARENA, HAMMONTON, NJ (US)

(21) Appl. No.: 15/698,526

(22) Filed: Sep. 7, 2017

Related U.S. Application Data
(60) Provisional application No. 62/384,671, filed on Sep. 7, 2016.

(51) Int. Cl. H04N 7/18; G06Q 10/08

(52) U.S. Cl. CPC H04N 7/185; H04M 1/7253; G06Q 10/0833

(57) ABSTRACT

A system and method for ensuring the safety of goods transported via highway, particularly humanly consumable goods, is taught by the present invention. Three main aspects include a smart phone hub, a portable sensor for monitoring the transported goods and a physical locking mechanism to lock the trailer, with all three monitoring and communication components managed by a remote central monitoring hub. According to the present invention, a truck driver uses a smart phone to interface between a trailer payload supervisor and the payload itself, to insure the safety of the transported goods. Upon loading a trailer, a truck driver uses a smartphone to 1) activate the internal sensor and 2) snap an image of the locked trailer (with a padlock and a license plate, for example). A padlock according to the present invention may be interfaced to the smart phone electronically, so that while in motion, the smart phone insures that the lock remains locked and the sensor remains in a non-alarm state. All data captured by the driver's smartphone application, trailer monitor and electronic lock is then transmitted, managed and securely stored through the remote central monitoring hub.

### PRIORITY CLAIMS

This application claims the benefit of U.S. Provisional Patent Application No. 62/384,671, filed Sep. 7, 2016, the contents of which are incorporated herein by reference.

### BACKGROUND OF THE INVENTION

Extensive systems have been deployed to use GPS (Global Positioning System) capabilities for the purpose of tracking vehicle fleets of, e.g., truck trailers, truck tractors and/or trucks; or railcars; or fleets of cargo containers. Such systems have been referred to as “asset tracking systems” and deploy asset-tracking units designed to be attached to individual vehicles. Each asset-tracking unit typically includes a GPS receiver that is capable of receiving GPS signals from a plurality of GPS satellites and determining the unit's location based on the GPS signals. Upon obtaining a position fix, the asset-tracking unit may report the unit's location via satellite communication (using another set of satellites) or the like to a central station. With such a system, the proprietor of the vehicle fleet may have close to real-time information concerning the whereabouts of all vehicles in the fleet. This may lead to significant efficiencies in planning and managing assignments of vehicles to particular tasks. In addition, an asset tracking system of this type may help in the detection of, and response to, irregularities such as theft of vehicles or their contents.

It has been proposed to install one or more sensors in or on a vehicle with the sensor(s) interfaced to the asset-tracking unit assigned to the vehicle. The sensor(s) may detect changes in conditions related to the vehicle such as opening or closing of a door of a vehicle, loading or unloading of cargo in or from the vehicle and (where the vehicle is a truck trailer) coupling or de-coupling of the vehicle to or from a truck tractor. The sensor(s) may provide signals indicative of such events to the asset-tracking unit, which may then report the events to the central station to increase the amount of information about operation of the vehicle that is present in the asset tracking system. In at least some cases, the system may notify a user/attendant of the events, and the user/attendant may take steps to respond to the events.

Potential disadvantages of reporting and responding to events in an asset tracking system may involve expenditure of resources such as battery power capacity of the asset tracking units, use of satellite communication systems and charges for such use, and attendant time and attention for receiving reports of events and/or responding to such reports.

Cargo theft in the United States has reached gigantic proportions. A disturbing number of those thefts (40% by some estimates) involve driver and warehouse personnel complicity. Trailer theft by deception is not uncommon. Fraudulent authorization papers presented to security by a driver will allow that driver to depart the facility with a stolen trailer. Many facilities are closed when trucks arrive, and drivers are dependent on prior dispatch information to accurately drop and hook trailers. Information received by a driver from dispatch prior to arrival at facility is rendered inaccurate if changes have been made at the designated facility and the driver is unaware of these changes.

At large busy facilities traffic control generally does not always have an accurate account of the disposition of trailers, dock doors or parking space that is already occupied. It is common practice at facilities for security to instruct an incoming truck to park the trailer in a designated parking area without assigning a parking space number to driver. Security and traffic control are dependent on driver to inform them of parking space location of parked trailers and the parking space location from which a trailer is retrieved for departure from the facility. It is not uncommon at large facilities for traffic control to dispatch a yard tug driver to go and “find” a particular trailer and report its location back to traffic control.

Crowded, disorganized parking of trailers at parking areas within the facility is commonplace. Equipment and property are damaged by drivers in the process of parking and retrieving trailers at these areas. Security at some facilities is non-existent. At other facilities, security consists of a security guard making rounds of the property at regular intervals. However, a security guard cannot be in all places at all times. Other measures of security presently employed include cameras and seals or locks on trailer doors, but cameras are easily rendered inoperable, and seals and locks can be cut with bolt cutters or a hacksaw.

Satellite communication is employed in specific areas of truck operations and is primarily a tracking system that ‘observes’ from space. However, satellite tracking, while useful in some areas of the industry, is susceptible to atmospheric and technical interference. It also does not address the continuous multiple tracking, loading and unloading, parking, damage control and security problems presently existing at large busy facilities.

In addition, the effectiveness of the satellite tracking system is dependent on an attachment to the trailer to accommodate satellite tracking signal, and any attachment to a trailer is vulnerable to vandalism, theft or deactivation. While some large facilities do have computerized tracking systems in place, they are simply that—tracking systems for containers within that particular facility. None are integrated into a security line, which alerts security and other authorities when a breach of security takes place.

More recently, the US Food & Drug Administration has enacted the Food Safety Modernization Act. The FDA Food Safety Modernization Act (FSMA) rule on Sanitary Transportation of Human and Animal Food is now final, advancing FDA's efforts to protect foods from farm to table by keeping them safe from contamination during transportation. FSMA has seven foundational rules proposed since January 2013 to create a modern, risk-based framework for food safety. The goal of this rule is to prevent practices during transportation that create food safety risks, such as failure to properly refrigerate food, inadequate cleaning of vehicles between loads, and failure to properly protect food, from farm to fork, so to speak.

The rule builds on safeguards envisioned in the 2005 Sanitary Food Transportation Act (SFTA). Because of illness outbreaks resulting from human and animal food contaminated during transportation, and incidents and reports of unsanitary transportation practices, there have long been concerns about the need for regulations to ensure that foods are being transported in a safe manner. The rule establishes requirements for shippers, loaders, carriers by motor or rail vehicle, and receivers involved in transporting human and animal food to use sanitary practices to ensure the safety of that food. The requirements do not apply to transportation by ship or air because of limitations in the law.

Specifically, the FSMA rule establishes requirements for vehicles and transportation equipment, transportation operations, records, training and waivers. With some exceptions, the final rule applies to shippers, receivers, loaders and carriers who transport food in the United States by motor or rail vehicle, whether or not the food is offered for or enters interstate commerce. It also applies to persons, e.g., shippers, in other countries who ship food to the United States directly by motor or rail vehicle (from Canada or Mexico), or by ship or air, and arrange for the transfer of the intact container onto a motor or rail vehicle for transportation within the U.S., if that food will be consumed or distributed in the United States. The rule does not apply to exporters who ship food through the United States (for example, from Canada to Mexico) by motor or rail vehicle if the food does not enter U.S. distribution. Companies involved in the transportation of food intended for export are covered by the rule until the shipment reaches a port or U.S. border.

Specifically, the rule would establish requirements for: (1) vehicles and transportation equipment: The design and maintenance of vehicles and transportation equipment to ensure that it does not cause the food that it transports to become unsafe. For example, they must be suitable and adequately cleanable for their intended use and capable of maintaining temperatures necessary for the safe transport of food; (2) transportation operations: The measures taken during transportation to ensure food safety, such as adequate temperature controls, preventing contamination of ready to eat food from touching raw food, protection of food from contamination by non-food items in the same load or previous load, and protection of food from cross-contact, i.e., the unintentional incorporation of a food allergen; (3) Training: Training of carrier personnel in sanitary transportation practices and documentation of the training. This training is required when the carrier and shipper agree that the carrier is responsible for sanitary conditions during transport; and (4) records: Maintenance of records of written procedures, agreements and training (required of carriers). The required retention time for these records depends upon the type of record and when the covered activity occurred, but does not exceed 12 months.

The result of FSMA is that the largest food distribution systems will be compelled to add a monitoring and safety cost to their transportation and logistics operations. However, the smaller entities will be presented with these increased as well. While FSMA purports to lessen the burden on the smaller operators, it does not go far enough. In reality, the small food operators (e.g., the “family farmer”) will find it next to impossible to comply with FSMA in a meaningful way, being compliant, yet in a cost effective manner.

So primary problems with the prior art are numerous. First, many systems rely on sensors that are permanently mounted to cargo containers or truck trailers. Fixed devices can become obsolete, and small time operators may find their subscription cost and updating to be cost prohibitive. Next, fixed sensors need to communicate with the outside world, so many are equipped with satellite transponders or cell phone or wireless interfaces. Again, this approach is very costly. Next, software that links trucks with truck operators and ties in purchase orders or manifest reports is often “enterprise” in nature, and therefore often cost prohibitive for small operators or inefficient even for larger operators. In addition, when the payload is of relatively low value, such as a regular crop yield, high cost fixed sensors, satellite communications enterprise software adds too much cost; yet, the problem is that even a routine crop like lettuce, while not itself valuable, needs to be safeguarded against food contamination, bio-terrorism and other threats to the food supply. In other words, the crop value isn't as critical as the potential damage a contaminated crop may cause in the food chain.

Very few of the prior art systems use the smart phone of a truck driver, and those that do lack the sophistication to insure food safety or cargo security from point to point with the ability to insure that even between various drivers and intermodal transit, a cargo load, once locked, is secure against damage and tampering. The prior art completely neglects to link the now commonplace personal driver smartphone with the outside world, including cargo sensors, locks, electronic Bluetooth locks, cargo monitoring software, scheduling software, purchase order and inventory management software, farming or agricultural production software and point of delivery warehouse tracking software or even end point grocery store inventory management software.

The prior art does not teach compliance with the Food Safety and Modernization Act through the use of a personally owned driver smartphone as the communications hub and lock verification mechanism. Yard management, fleet management, mobile dispatch and delivery, cross-docking, terminal and distribution center operations, shipping and railway operations, GPS, telemetry, remote management and RFID solutions quickly add cost to operations. Most institutional transport companies are reluctant to rely on personal smartphones for fear of a security breach, but in many cases, particularly with respect to FSMA compliance which has been extended to even the smallest of operators, relying on the generally present driver smartphone saves significant expenses. If a driver does not have a capable smartphone (with camera and Bluetooth interface and a carrier connection), a transportation network may decide to drop that driver or provide a driver with a rented smartphone for transport usage, much the same way some cab companies operate for transporting people. Finally, mechanical seals (plastic or metallic) do not provide real time monitored solutions to the problem at hand.

### SUMMARY OF THE INVENTION

The use of a central monitoring system that aggregates and analyses all data collected from the various components of the overall system serves as a backup or secondary information source when either the driver or client require assistance or information verification. The central monitoring system is able to collect, organize and monitor all data collected from various sensors and mobile application user input. Preventing, actively monitoring and resolving transportation issues with the central system administrator increases overall transportation efficiency and operation. All data is securely stored in transportation logs that can be accessed by the client to achieve compliance for current FSMA regulations.

All incidents pertaining to equipment or property damage are immediately communicated to the central monitoring system, whereby data is analyzed by administrative personnel and action is taken to aid the driver in resolving the situation. All data and subsequent communication is then stored on a secure server and the client has access to the full vehicle data logs and incident reports. The central security system administrators primarily serve as a data communication bridge between the client, the driver and the broker, as well as notifying emergency services if necessary. Data collected by the central monitoring system can be transported via cellular signal and Wi-Fi signal where available.

According to the present invention, trailers and tractors need not be modified in order to be compliant with FSMA. The leading manufacturers of trailers include Utility, Great Dane, Xtra and others. Many trailer manufacturers are offering equipment upgrades in order to meet FSMA requirements, yet, trailers have a long time useful life. In other words, as trailers are replaced it is somewhat feasible to buy new ones equipped with FSMA compliant telemetry equipment, but even then, the trailer operators are then presented with a high monthly charge for monitoring. The key feature of the present invention is the fact that most if not all truck drivers carry smart phones, equipped with Bluetooth, NFC, GPS and other common interface protocols. Consequently, according to the present invention, the truck driver's smart phone serves as a hub for the present invention.

Next, FSMA is concerned with food protection from farm to fork. Once a trailer is loaded with food, its temperature may be critical. Also, access to it is critical. Consequently, according to the present invention, an enhanced Trailer Monitoring Device (TMD) is taught, that uses Bluetooth (short or long range, as applicable) or NFC to communicate with the smart phone of a truck driver. The TMD may include one or more of the following sensors: temperature, shock, elevation, light presence, a camera or video monitor, a microphone or noise detector, an ultra-sonic motion detector, an infrared image detector, recording means for any of the above and a portable means of power supply, either long term battery or a rechargeable battery supply. According to the present invention, the TMD may have a fastener mechanism for holding it to the interior wall, floor or ceiling of the interior of a closed trailer. For example, if the walls of the trailer are magnetic a magnet may be used or industrial strength Velcro, for example.

Advantageously, according to the present invention, the TMD's are completely portable and are not pre-disposed to be associated with any particular trailer, tractor, driver or pad lock. Each TMD does have a unique embedded electronic serial number (ESN) so that it may be used for any load, by any driver, with any tractor, for any destination or cargo type or style. The TMD's may be supplied in rechargeable pairs or groups so that they are configured for multi-segment trips. In that manner, a series of TMD's may be associated with a particular broker, carrier or company. If redundant by pair, one TMD may be recharging while another is in service inside a trailer, locked for the duration of a transportation segment. The TMD may be equipped with a battery life sensor so that its data stream output is readable by monitoring equipment so that battery life may be optimized and monitored.

The TMD may be redundant but is intended to be a universally transportable device. Importantly, the “hub” of data operations according to the present invention is the smart phone owned or under the control of the truck driver. The TMD is locked within the trailer or the cargo container, so that the TMD travels with the load that must be protected under FSMA guidelines. It is intended that a TMD stays with its payload until the payload reaches its final destination.

Accordingly, the TMD is designed to consume a minimal amount of power. For example, the TMD will generally not, according to the present invention, include GPS or geo-location circuitry, and will not include warning indicators like sirens or flashing lights. In addition, it is intended that the TMD emit only encrypted data, and transmits only, except, that it may receive configuration data from a driver's smart phone. In turn, a driver's smart phone may use the public cellular network to allow for control signals to be passed to and status signals to be read from a TMD. Accordingly, with the present invention, it is not anticipated that a TMD will have its own internal cellular interface, but rather, will rely on the driver's smart phone for operation.

The TMD may be temperature proof and waterproof and made to be durable, so that it may be used over and over again, and travel with any payload. Importantly, a TMD may be fitted to include many more sensors that are activated in connection with any given payload transport operation. For example, if a payload is a collection of precious stones, the FSMA characteristics of the TMD may be turned off, such as temperature sensing. However, the infrared sensing and video monitoring functions activated, by way of status and control signals passed to the

TMD by way of a cloud based control system, tethered to the TMD by way of a driver's smart phone. The subscription plan selected by the payload transport company or the payload owner or insurer will reflect what is being transported and its cost of transport. In turn, payload transporters or owners or even brokers may decide that certain loads are more valuable than other loads or that certain criteria need to be monitored by a TMD more closely than others, and therefore, the cloud based system will enable payload transporters or owners to activate the correct array of sensors within the TMD, and accordingly, pay for those sensing operations to be performed by the TMD on a per time unit basis, per mile and based on the criteria that are desired to be monitored. So, continuous “in the dark” video surveillance by a TMD may cost a lot more than temperature monitoring for FSMA purposes.

According to the present invention, the TMD may be a unit which is hand held, and one or several of them may be deployed within a given container, such as a locked trailer containing fruit and vegetables, or even precious cargo, or even hazardous waste products. By deploying TMD's within said space much the same way stationary fixed spaces are monitored by the well-developed security industry. What distinguishes the present invention is that the TMD's are universal in their construction, and for FSMA compliance purposes, may simply “watch” to make sure that the rear door of a trailer has not been opened, and that temperature is maintained. The TMD will lack the ability to interpret its own data, mainly because it is in a slave relationship with the driver's smart phone, which aside from advantageous native code (iOs or Android), is enslaved to the overall Monitoring Control System, or MCS.

A driver's smart phone is the central hub according to the present invention. It will need to have a camera, a GPS unit and a cellular interface. According to the present invention, a significant amount of savings is achieved for FSMA compliance because it is recognized that in the present day, most truck drivers have relatively modern smart phones. That is the key aspect to the present invention, whereby at the lowest value of cargo, for FSMA compliance, a TMD will be very basic and all GPS and network connectivity is achieved FOR FREE by the transporters, farmers, brokers and grocery store chains and their warehouses. In other words, when a load is hazardous waste or precious stones, security costs are overlooked. However, when the cargo amounts to lettuce, the margins are tight.

Paying for high cost monitoring becomes impractical from a cost accounting perspective. But, protecting the general public from farm to fork is a primary aspect to FSMA. Accordingly, the utilization of WHAT IS ALREADY AVAILABLE becomes critically important. Therefore, according to the present invention, a TMD interfaces with a driver's owned or controlled smart phone and that in that manner, the cargo's adherence with FSMA guidelines is assured. Conversely, if a farmer or transport company is forced to purchase new trailers with TMD's build into the trailer, it may be become obsolete, cost too much and not scaled in proportion to what is being transported and monitored and protected.

The driver's smart phone must preferably contain a camera according to the present invention, and possess a Bluetooth or NFC type interface to link with the TMD, and to enable it to photograph or image the back of the trailer AS IT IS LOCKED. All trailers have identification indicia on them—driver licenses, permit numbers, DOT numbers and so forth. According to the present invention, once a cargo load is placed within a trailer, the rear doors are closed and LOCKED. FSMA guidelines require that food be locked during transport to insure non-tampering by those who would wish to do harm to the general public, e.g., bio-terrorism. According to the present invention, a driver locks the back doors to the trailer, and then snaps an image of the back door with its lock, showing the lock is locked and that a certain lock is attached and has been attached to a particular trailer, with its visible indicia. At that point, according to the present invention, that image is made part of the data collected by the MCS. So that at the moment a driver “locks his load”, the MCS is aware of the electronic serial number of the driver's smart phone, its GPS location, and has an image of the back of the trailer locked and knows what was loaded into the trailer, based on purchase orders and bills of lading as to each individual load. The time of day and date are known, as is the driver's identity. Position may be tracked, and of course, the TMD is also providing status signals to the driver's smart phone, which are in turn transmitted to the MCS.

According to the present invention, a new generation of so-called Bluetooth locks may be employed. Typical lock companies such as Masterlock and Medeco provide Bluetooth locks, which may be opened and closed with a traditional physical key, OR, be locked and unlocked (opened and closed) by way of Bluetooth signals from a dedicated software application. According to the present invention, Bluetooth locks may be adapted and may in turn be controlled by a software application running on a driver's smart phone, so that the MCS may have the benefit of the lock's real time status. By way of an automated lock, the MCS may even take control of when a lock is unlocked. Therefore, the MCS controller or supervisor may dictate when a lock may be locked and unlocked, insuring complete safety and security from farm to fork.

The minimization of cost is a primary aspect of the present invention. Locks may also be supplied in redundant pairs, rechargeable, so that a driver may always have one “at the ready” to lock a load. So for low cost FSMA compliance, a driver may have two simple TMD's with two simple electronic locks, and a charging base so that a driver's smart phone can be used to replace much of the traditional costly surveillance equipment associated with trailer safety or FSMA compliance. As new FSMA guidelines kick in and begin to apply more and more vigorously with respect to the smallest family farmers, a low-cost FSMA compliance solution is desperately needed, and is provided according to the present invention.

A primary aspect of the present invention is that all phases of freight transit may be monitored, including load tenders, pickup, transit, and delivery. While each hand off could present a risk, the present invention builds an electronic certificate that is a chronology of the load from when it is inserted and locked into a trailer until it is unlocked at a destination, often a warehouse. These steps may apply to highway transportation, rails, sea or via air. But in all cases, when a load is received and locked, a supervisor (generally a truck driver) “locks” the load. At the time of locking, the driver will use his smartphone to snap a picture of a padlock as it has secured the rear door of a trailer. The padlock may be a manual padlock or an electronic lock, for example, Bluetooth, interfacing directly to the smartphone or hub. When the driver snaps the image of the lock, hash marks in the view finder or smartphone video display may shoe a region to place the license plate number or other surface identification indicia on the trailer itself. Accordingly, upon snapping the locking picture, the driver has recorded a time, place (GPS), container number and lock (with or without a serial number or electronic serial number), and a remote database records the precise start point for securing that load.

Accordingly, a digital certificate is created which establishes that the load has been indeed locked and is secure. As an additional measure of security, the internal monitor can synchronize with the smartphone and verify that the load is not tampered with. For example, infrared sensors, shock sensors, cameras, temperature sensors, gas chromatographs, and so forth, may be portably affixed to the inside of the trailer before it is closed and locked. Each of said sensors will have unique electronic serial numbers and then become associated with the digital certificate. In that way, the remote database and the smartphone will create and then monitor the status of the load, its safety, and its position via GPS readings from the driver's smartphone as it travels between endpoints. The remote database will store the digital certificate and track its position over time, its safety and status parameters and correlate it with all outstanding purchase orders, incoming and outgoing manifests and any other system wide inventory management systems.

Accordingly, a major cost savings is achieved because the primary in-transit communications mechanism is that of a driver's personal smartphone; a primary location component is the GPS associated with a driver's personal smartphone; and the hub and visual record of the locked trailer is stored and then transmitted by way of the driver's personal smartphone. Accordingly, the digital certificate contains many data fields pertaining to the secured load and is unique to the actual load secured and under transit, and may be passed on from driver to driver until the load reaches it endpoint.

These and other features, embodiments, and aspects of the present invention can be appreciated from the following drawing description and detailed description of the preferred embodiment. Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

FIG. 1 is a side profile overview of the monitoring system components within a tractor trailer.

FIG. 2 depicts the rear door and locking mechanism of the tractor trailer monitoring system as shown on the application monitoring system photo verification module on a user's smartphone device.

FIG. 3 is a block diagram overview of the system and how it is used.

FIG. 4 is a block diagram of the mobile application monitoring system user interface.

FIG. 5 is a rendering of the smartphone application user interface when accessed on the user's mobile device.

FIG. 6 is a block diagram of the of the communication between the monitoring device, the electronic lock, and the mobile application.

FIG. 7 is a block diagram of the event detection process performed by the electronic lock.

FIG. 8 is a block diagram of the status and event detection process performed by the monitoring device.

FIG. 9 is a rendering of the central data monitoring and control system administrative user interface.

FIG. 10 is a block diagram of the driver system transportation monitoring components in relation to the control system administrator and data storage the secure server.

FIG. 11 is a block diagram of the system administrator notifications function connected to the driver, client, and broker.

### DETAILED DESCRIPTION OF THE DRAWINGS

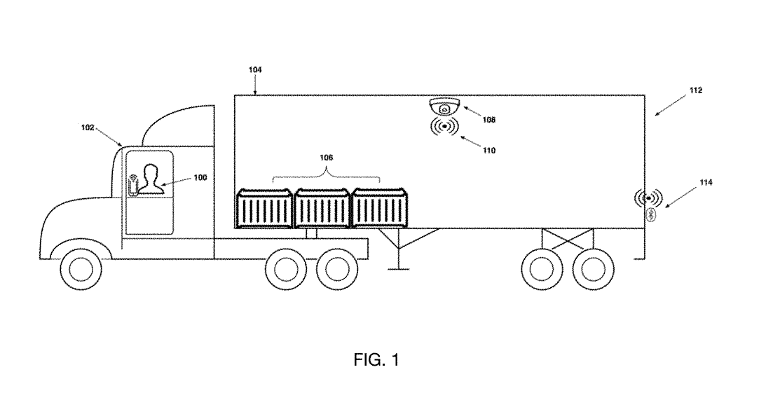

FIG. 1 is a side profile overview of the monitoring system components within a tractor trailer. In accordance with the preferred embodiment of the present invention, the overall monitoring system consists of 2 components, one paced inside the trailer and one placed outside on the rear door, that communicate with an application downloaded to the user's smartphone device 100, allowing the user to monitor the cargo and receive alerts if there are any changes detected by the the other monitoring components. The user and the mobile device 100 are primarily located in the front tractor trailer 102. The user is responsible for transportation of the assets 106 located within the semitrailer 104 attached to the tractor trailer. The removable monitoring component 108 is placed within the semitrailer 104 in the most optimal position in order to act as a visual surveillance device within the semitrailer, as well as monitoring and transmitting the conditions inside the semi-trailer, including but not limited to monitoring temperature, motion and light.

The monitoring component 108 communicates wirelessly 110 with the application on the user's mobile device 100. The monitoring component also communicates wirelessly with the electronic locking device 114 placed on the rear semitrailer door 112. The wireless communication 110 between the mobile application 100, the monitoring component 108, and the electronic lock 114 is transmitted through Bluetooth technology or a similar wireless device pairing technology. The electronic lock 114 transmits alerts and status updates when there are any changes detected, such as the lock being opened or compromised. The electronic lock 114 communicates with the monitoring component 108 to determine if there are status changes within the semitrailer, thereby sending alert and status update transmissions to the mobile application 100.

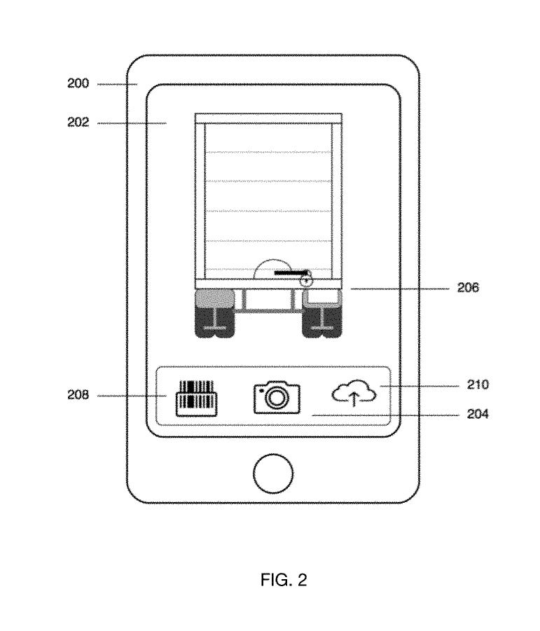

FIG. 2 depicts the rear door and locking mechanism of the trailer monitoring system as shown on the application monitoring system photo verification module on a user's smartphone device. In accordance with the preferred embodiment of the present invention, the application on the user's mobile device acts as a data transmission and storage hub of all alerts and status updates transmitted from the monitoring component and electronic lock. One aspect of the present invention is a photo verification module that is integrated with the camera component of the mobile device 200. The user uses the application to take a photo 204 of the rear door of the semitrailer 202 to confirm that the door is locked with the electronic lock 206 and the assets are secure. The photo is stored with a date and time stamp as well as the geolocation data. The application stores this data on an external application server. The application photo verification module also serves as a data scanning function 208, detecting, scanning and storing the license plate information and other key identification data including but not limited to the trailer ID number, identification barcode or other readable code such as a Quick Response (“QR”) code. The photo data, date, time, location and scanned items are stored on a secure external application server 210.

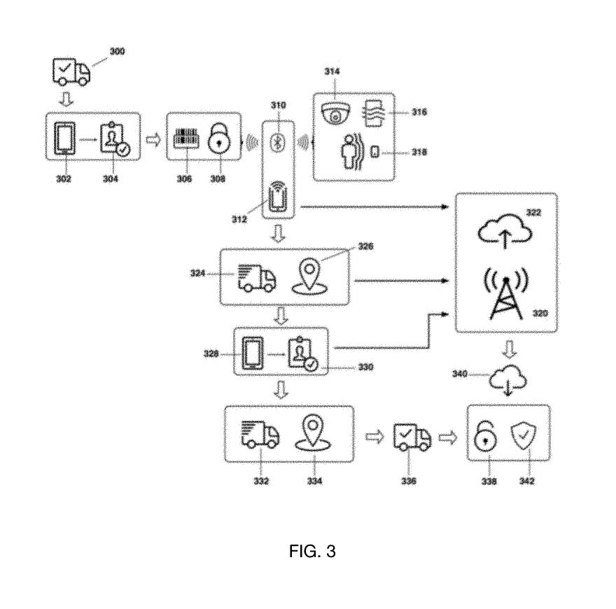

FIG. 3 is a block diagram overview of the system and how it is used. According to the present invention, the system is applicable to transportation of assets, and each asset transport is initiated with the system user securing the asset inside a designated tractor trailer at the designated pick up location 300. Once the asset is securely locked in the trailer, the user then logs in to the application using a mobile device 302. The user enters secure login verification details 304 that include a username and password, facial recognition or thumbprint verification. Once the identity of the user has been verified within the application, the user proceeds to complete the asset intake and pickup confirmation by using the scan and camera modules within the application 306, and verify that the electronic lock 308 is securely locked on the rear door of the trailer. The user also must verify that the Bluetooth wireless signal 310 is communicating between the electronic lock 308, the user's mobile application 312, and the asset monitoring component 314 inside the trailer. The monitoring component 314 wirelessly transmits data that includes motion detection 318, and internal temperature 316, between the electronic lock 308 and the mobile application 312. This data is aggregated and wirelessly transmitted 320 to be stored in a secure wireless application server 322 for access by all system users authorized to view this specific set of data. Once the asset intake process is complete, the pickup is confirmed and the asset is now designated as in transit to a designated location 324.

The mobile application transmits real-time geolocation data 326 of the tractor trailer wirelessly 320 to the secure application server 322. If the asset transportation itinerary specifies more than one designated asset transportation user, the first user is responsible for arriving at a designated point to initiate asset hand-off to the next user. The intake process is repeated, with the second user verifying that the asset is secured. The secondary user must complete the verification process using their mobile device 328 and completing the login verification and intake process 330. This asset hand-off data is then wirelessly transmitted 320 to the secure application server 322. Once the secondary user completes the hand-off and asset intake verification process, the asset is now designated as being in transit with the secondary user 332 and tracked using geolocation data 334 from the secondary user's smartphone. Once the asset reaches the delivery destination point, another hand-off is done with the delivery contact system user 338 and the asset status is verified and marked as complete on the mobile application 336. The delivery contact system user is able to access all asset transportation data by downloading a detailed report from the secure application server 340 by logging in to the system application 342.

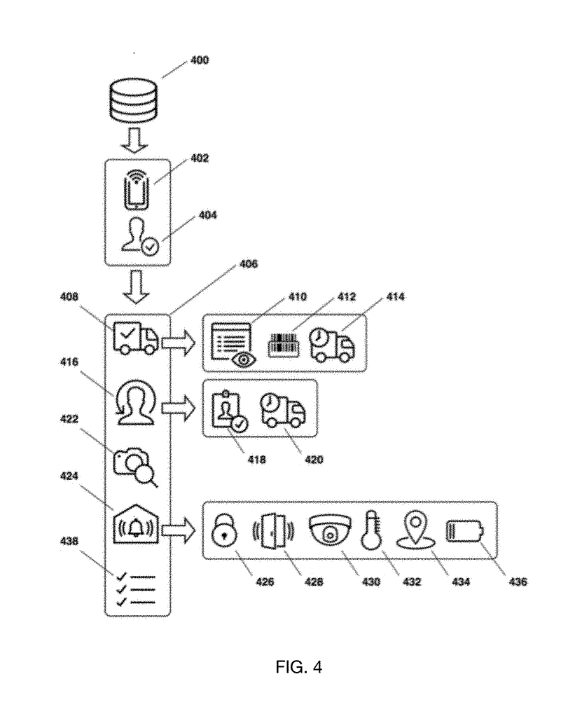

FIG. 4 is a block diagram of the mobile application monitoring system user interface. In accordance with the preferred embodiment of the present invention, the user can access the system application through a wireless mobile device 402. All data collected in the asset transportation monitoring system is stored on a secure external application server 400. The server wirelessly transmits the data to the application on the user's mobile device 402. To access the data, the user enters secure login verification details 404 that include a username and password, facial recognition or thumbprint verification. Once the identity of the user has been verified within the application, the user is able to view the application interface menu 406. Through the interface, the user is able to access real-time information regarding asset transportation in progress 408. Selecting this module allows the user to access the details pertaining to the asset specifications and delivery information 410, such as the designated delivery address and contact information of the recipient. Through this module, the user can access specific identification profile information 412 related to the asset and the tractor trailer, as well as a full itinerary 414 that includes a Global Positioning System (“GPS”) map feature and real-time updates on the scheduled asset pickup, hand-off, and delivery date and time.

The user is able to report a user hand-off event 416, whereby the user can verify and confirm the secondary user 418, and log the hand-off information, including the location, date and time, into the assignment database on the secure application server 420. The user can access the photo verification module 422 to visually log the status of the asset in the secure application server. The user is also able to view all alerts transmitted from the monitoring device 430, and the electronic lock 426, including but not limited to: rear trailer door movement 428, temperature inside the trailer 432, location status of the asset in relation to the current detected geo-location of the trailer 434, and the battery status for both the monitoring device and the electronic lock 436. The user can also view the history and status data log of all previous asset transportation assignments completed, as well as upcoming assignment information 438.

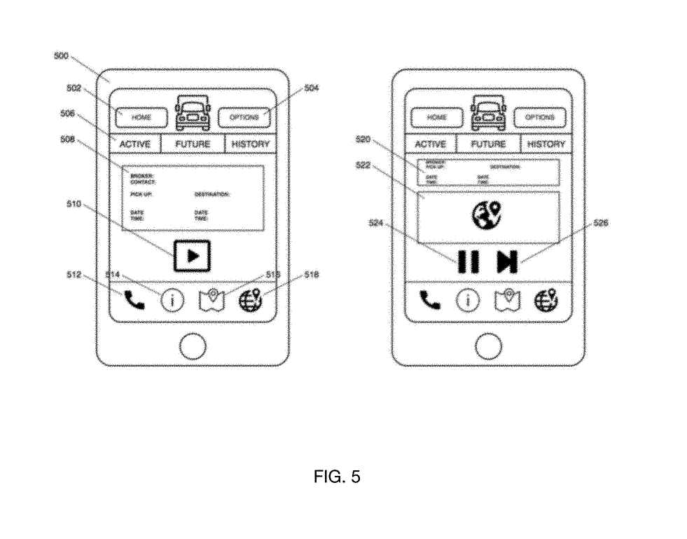

FIG. 5 is a rendering of the smartphone application user interface when accessed on the user's mobile device 500. According to the preferred embodiment of the present invention, the mobile application is a key component that serves as an information and communication hub between the user, the trailer monitoring device, the electronic lock, the secure application server, and all authorized parties related to the transportation of a specific asset. The main page of the application user interface is accessed one the user verifies login information. Once the user identity is verified, the user interface is displayed and can be accessed at any point throughout the application by selecting “HOME” 502. The user can access system settings mobile settings by selecting “OPTIONS” 504. The user can navigate between “ACTIVE” asset transportation data, “FUTURE” asset data for upcoming assignments, and “HISTORY” data related to previous asset transportation assignments in the top navigation banner 506. The user interface displays key data related to the current asset transportation assignment on the home page, including the broker, the contact, the pick-up and destination addresses, date and time for each 508.

The user initiates the start of the assignment by selecting the start button 510 on the main page. Once the user starts the assignment, a real-time updated Global Positioning System (“GPS”) enabled map is displayed 522, and this location data is time stamped and saved on the secure application server assignment log. The user also has the option of viewing a full map overview of the assignment by selecting the GPS icon 518 located on the bottom banner. Once the assignment has started, the user can select the pause icon 524 to log in break times and the stop icon 526 when the assignment is complete. For the duration of the active assignment, relevant information is condensed and displayed on the main interface 520. The user can can communicate with relevant contacts directly by selecting the phone icon 512 on the bottom banner, whereby the user can select if they need to call, message or e-mail the contact. The user can access system information to retrieve a status update from the monitoring device and the electronic lock by selecting the system information icon 514. The full assignment itinerary details can be accessed by selecting the itinerary icon 516 on the bottom banner menu.

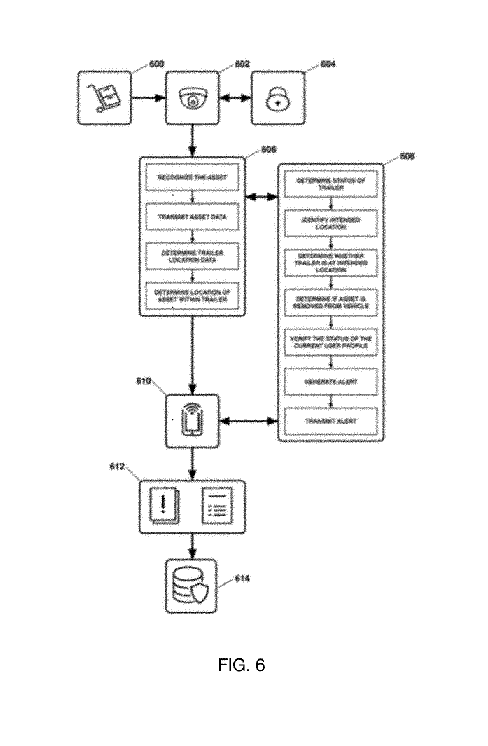

FIG. 6 is a block diagram of the of the communication between the monitoring device, the electronic lock, and the mobile application. In accordance with the preferred embodiment of the present invention, the assets 600 placed inside the trailer for transport are monitored by the monitoring device 602 secured in an optimal location inside the trailer. The monitoring device communicates wirelessly with the externally located electronic lock 604 to transmit data pertaining to the status of the rear trailer door. The primary status actions 606 performed by the monitoring device consist of: recognizing the asset within the trailer; transmitting asset data; identifying trailer location data; and determining the location of the asset within the trailer. The monitoring device 602 then performs a series of secondary status actions 608 that include: determining trailer status; identifying the intended location; determining whether trailer is at the intended location; determine if asset is removed from the trailer; verifying the status of the current user profile; generating an alert; and transmitting the alert to the mobile application. Once this additional data is transmitted to the mobile application 610, an alert notification is generated and the transmitted event data is logged into the job report 612. The alert, event data and report are all transmitted and stored wirelessly to the secured external application server 614.

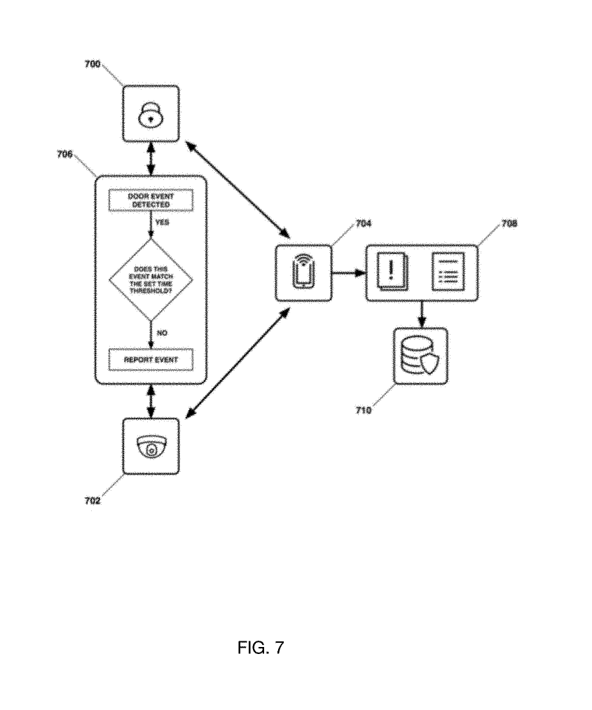

FIG. 7 is a block diagram of the event detection process performed by the electronic lock. In accordance with the preferred embodiment of the present invention, the electronic lock 700 is secured to the rear door locking lever of the trailer. Once it is locked and activated by the user through the mobile application, the electronic lock 700 will communicate with the monitoring component located inside the trailer and transmit status updates and alerts to the application 704 on the user's mobile device. The primary function of the electronic lock 700 is to monitor status of the trailer door 706. If the electronic lock is opened or if the trailer door is opening, the electronic lock 700 registers this as an event.

The lock can be set to certain parameters, including but not limited to a timer through the application to transmit events based on a specified time frame to other events. If this event exceeds the set parameters, the event is transmitted as an alert or status update to the mobile application 704. The electronic lock 700 also communicates with the monitoring component 702 inside the trailer to verify if the external event corresponds with any events occurring inside the trailer. The monitoring component 702 can detect additional corresponding events related to motion and light sensors that can potentially occur in a detected door event 706. Once this additional data is transmitted to the mobile application 704, an alert notification is generated and the transmitted event data is logged into the job report 708. The event data 708 can include the date, time, and location in the report for reference. The alert, event data and report are all transmitted and stored wirelessly to the secured external application server 710.

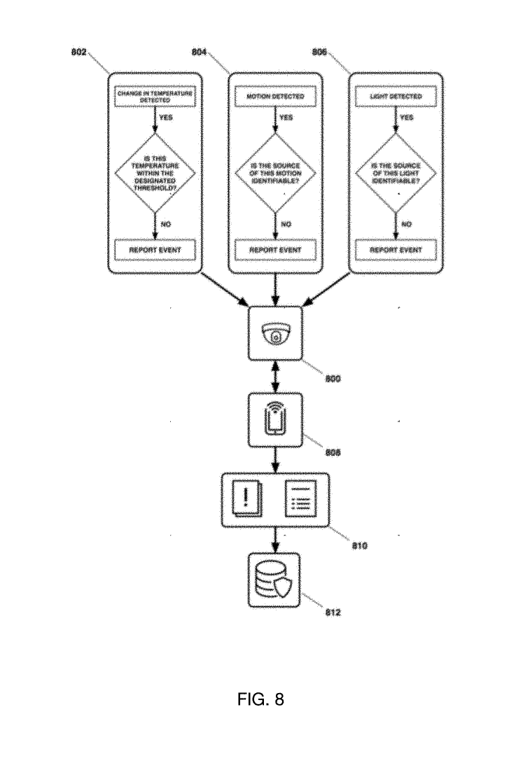

FIG. 8 is a block diagram of the status and event detection process performed by the monitoring device. In accordance with the preferred embodiment of the present invention, the monitoring device 800 is secured in an optimal monitoring location inside the trailer with an unobstructed view of the asset. The primary function of the monitoring device 800 is to detect changes in the conditions inside the trailer to secure the asset. A variety of sensing functions can be integrated into the monitoring device 800. One specific function is to detect a change in trailer temperature 802, and determining if there is a temperature change that exceeds pre-set temperature parameters, whereby an alert is transmitted to the mobile application 808. Another function is to detect motion inside the trailer 804, determining if the source is identifiable and generating an alert 808 if the motion source cannot be identified in the system parameters. A third function is to detect changes in light within the trailer 806, identifying the location of the light source, and transmitting the alert to the mobile application 808. Once this additional status data is transmitted to the mobile application 808, an alert notification is generated and the transmitted event data is logged into the assignment report 810. The alert, event data and report are all transmitted and stored wirelessly to the secured external application server 812.

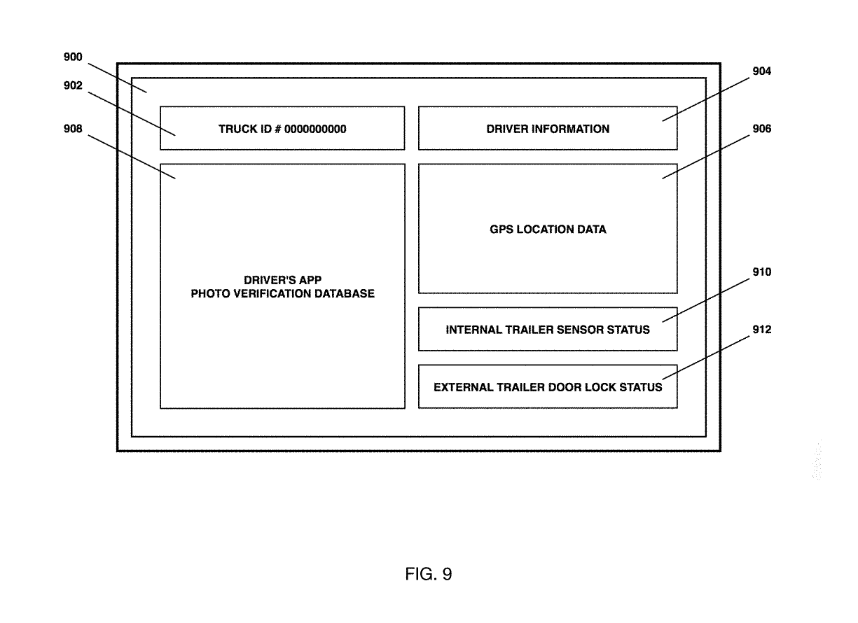

FIG. 9 is a rendering of the central data monitoring and control system administrative user interface. In accordance with the preferred embodiment of the present invention, the Admin Control Program interface 900 of the data repository system allows the designated system administrator 902 to access all aggregated data remotely and on a secure system server. The admin program menu 904 grants the administrator access to all data for “active orders” 906, upcoming or “pending orders” 908, and “past orders” 910 from the secure database server. There is also a system settings option 912 to set up administrative parameters. The main page of the interface allows the administrator to monitor all recent alerts 914 for active orders in real-time, listing all events transmitted from the driver application, the trailer monitor and the electronic lock. The administrator can access each order using the purchase order number. When a purchase order number 918 is selected, all information related to each order is displayed on a “purchase order” screen 916.

The administrator can access all itinerary information for the purchase order 918, including: client information 920; cargo contents 920; cargo pickup origin 924; and the cargo delivery destination 926. A complete detail of order events is accessed through the event log 928. All image data taken by the driver using the driver app, including timestamped images of the cargo followed by the lock in the secure locked position is viewed within the image verification database 930. The location of the driver and the cargo is shown on a real time GPS enabled map 932, displaying live, time stamped geo-location data collected from the driver's mobile application. The status of the internal trailer sensor and any alerts detected are updated and can be monitored in real time 934, with all data time stamped and entered into the secure system log. The status of the external trailer door electronic is also collected, time stamped, stored and displayed 940 for the system administrator. The data displayed in each purchase order overview panel increases the security, transportation data entry, log verification and accountability. Information pertaining to the truck identification number 936 is displayed as a primary means of verification between the driver, the client, and the central administrator. The administrator can view driver information collected from the driver profile 938, including but not limited to driver's license information and photo; all related training and certification data; contact information; driver experience; asset specializations and relevant system notes. The order screen also displays data of the vehicle owner 942 and the purchase order broker 944 for additional administrator reference. The administrator control program 900 serves as a key data communication bridge between the driver, the broker and the client.

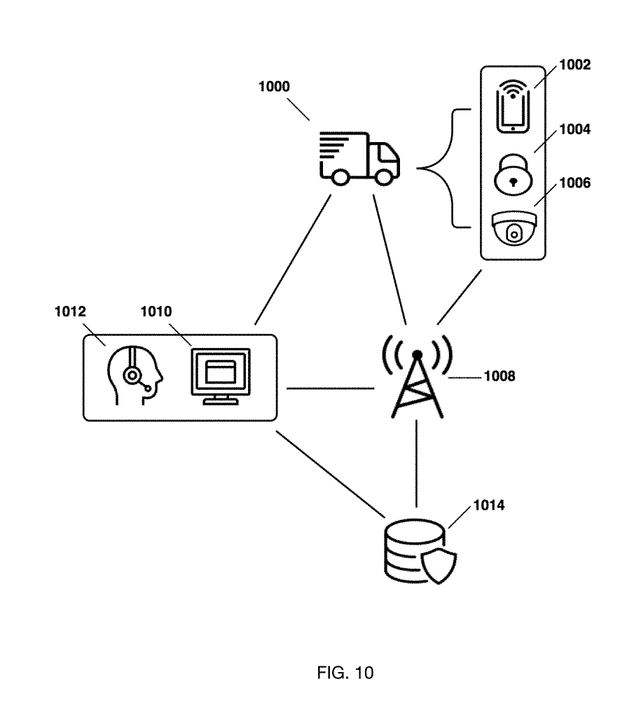

FIG. 10 is a block diagram of the driver system transportation monitoring components in relation to the control system administrator and data storage the secure server. In accordance with the preferred embodiment of the present invention, the driver component 1000 is actively transporting goods that are monitored by an interior trailer monitor 1006 and secured by an electronic lock 1004. The trailer monitoring system 1006 and the lock communicate wirelessly with the mobile application accessed through the driver's mobile device 1002. The driver application component 1000 wirelessly transmits data 1008 to the central monitoring system 1010, whereby the data is analyzed and processed by the system administrator 1012. All transmitted data and communication is wirelessly transmitted and stored in a secured server 1014. The driver 1000 can transmit and access data directly with the secured server 1014 through the mobile application 1002. The mobile application 1002 can also connect the driver 1000 directly to the system administrator to make requests or obtain further data analysis that is displayed on the central monitoring system 1010.

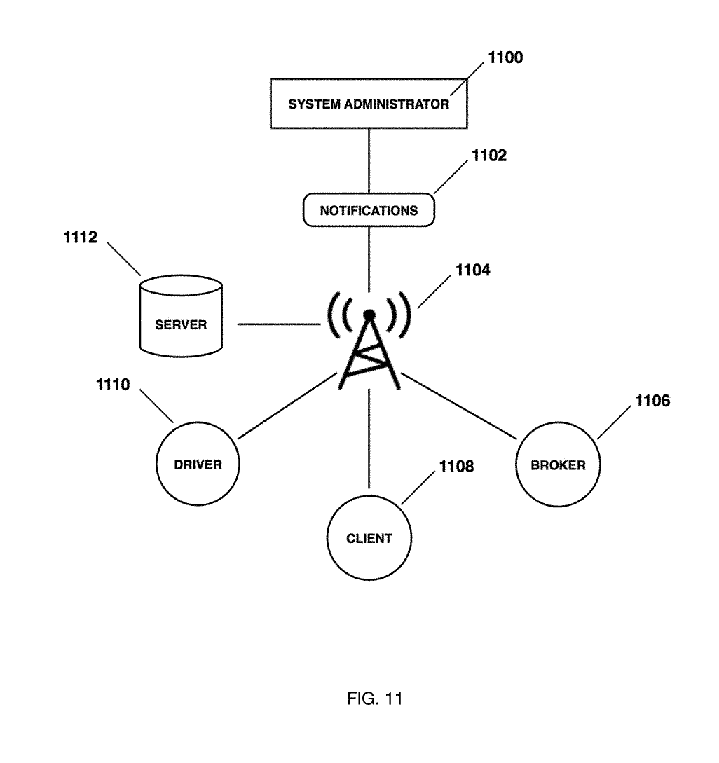

FIG. 11 is a block diagram of the system administrator notifications function connected to the driver, client, and broker. According to the preferred embodiment of the present invention, the system administrator 1100 has the ability to initiate and override all notifications 1102 transmitted within the system. All notifications are transmitted wirelessly 1104 to the broker 1106, the client 1108, and the driver 1110. The system administrator 1000 can also oversee and approve notifications wirelessly transmitted by the broker 1106, the client 1108, and the driver 1110 remotely through a wireless 1104 mobile application. All notifications are stored in the secure system server 1112 where they are compiled in a transportation record.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

What is claimed is:

1. A method of transmitting data from a vehicle corresponding with an associated trailer via a smartphone operated by a driver of said vehicle, the method comprising steps of:
inputting into said smartphone load parameters including a geographic loading point, a geographic unloading point, and a load identification parameter;
using said smartphone to collect an image of said trailer storage area after said storage area cleanliness has been verified by said driver;
using said smartphone to collect an image of an exterior of said trailer and a lock associated with said trailer which functions to secure said load contained within said storage area; and
said smartphone communicating to a host transportation database said load parameters indicative of the geographic position and condition of said load over a range of geographic positions and time intervals commencing from its loading event through until its unloading event.
